(19) United States
(12) Patent Application Publication
(10) Pub. No.: US 2021/0300114 A1
(43) Pub. Date: Sep. 30, 2021

(54) Corner caster attachment

(71) Applicants: Darren Eason, Munster, IN (US); Glenn Reyna, Dyer, IN (US)

(72) Inventors: Darren Eason, Munster, IN (US); Glenn Reyna, Dyer, IN (US)

(21) Appl. No.: 17/213,354

(22) Filed: Mar. 26, 2021

Related U.S. Application Data
(60) Provisional application No. 63/001,084, filed on Mar. 27, 2020.

(51) Int. Cl. B60B 33/00

(52) U.S. Cl. CPC B60B 33/0015; B60B 2360/104; B60B 2900/572; B60B 2900/321; B60B 2900/311

(57) ABSTRACT

A caster attachment is provided. The caster attachment includes a body portion having an angled plate attached to a bottom plate. The angled plate and bottom plate fit an outside corner of a case. A fastener receiving portion is affixed to the body portion. The body portion has a hole for receiving a rivet. The fastener receiving portion has a threaded bore. There is a fastener that is attached to a wheel. The fastener is attachable and detachable to the threaded bore.

### CROSS-REFERENCE TO RELATED APPLICATIONS

The present application claims the benefit of U.S. Provisional Patent Application No. 63/001,084, filed Mar. 27, 2020, the entirety of which is hereby incorporated by reference.

### BACKGROUND

There is an expanding need for packaging and transporting reusable electronics & fragile devices. Due to this increase, cases for packaging and transporting such equipment are in high demand.

There are several common cases that have been used for these transport needs. Too, designers and engineers perform custom case design, testing and packaging. This requires experience with numerous container types and styles and a thorough and in-depth knowledge of packaging requirements. There is a high demand for custom containers that are both modular in concept and designed on an individual basis suitable for the dunnage to be packaged and transported.

Such transport needs involve many types of fragile and valuable equipment. It is a primary concern to provide users with the very best design, construction and appropriate type of case needed to protect this valuable equipment. So, cases are made with attention to the case materials such as fiberglass, ACX grade plywood or high-density polyethylene, aluminum, steel, and interior foam materials. Stronger cases mean heavier design and smaller space for the equipment to be stowed.

The case industry must to comply with all applicable ATA (Air Transport Association of America) Specifications and parameters. Cases are tested according to various methods such as MIL-STD. 810 and the DFPA (Defense Fire Protection Association) testing for fire retardancy.

Cases are transported via any one of several carriers. The cases, which refers to any container used to transport valuable items, must be within the size and weight limitations enforced by the carriers. For instance, common carrier truck lines restrict the size and weight of transported cases.

Once the cases are shipped, a user will unload the cases from the shipper. Then the case is transported again and again between various destinations where the valuable equipment stowed in the case is used.

The inventors noted the problem with size and weight of cases in a world where there is an expanding need to transport fragile or valuable equipment. The inventors also noted the need for users to safely transport cases loaded with increasingly more fragile and valuable equipment. For example, a disc jockey needs to haul very valuable digital equipment from one venue to another then back to the warehouse.

Presently, case makers are merely add wheels to a case to ease transport. But, adding wheels adds to the dimensions of a case. Makers use larger wheels to allow transporting heavier weights. But this too adds to the case's dimensions and fails to redistribute the center of gravity.

One problem with these designs is that shipping standards restrict overall case dimensions. Too, cases are becoming heavier and smaller thus changing the weight distribution.

There is a need in the industry for an apparatus that allows shipping of cases using the case's true dimensions and provides wheeled transport with better weight distribution.

### SUMMARY

The present invention provides for an apparatus that satisfies this need. The apparatus comprises a caster and an attachment for the caster which engages a case at the case's corners. The invention would be located at the corners of a case but yet extend beyond the perimeter of the case. This provides a pillar of support when the contents in the case raise the center of gravity and increase the potential for the case tipping. So, one benefit of the invention is providing increased mobility and stability to a case.

The present invention relates to a caster attachment which may be used to attach a wheel to a case, for example cases used for electronics & fragile device packaging. The caster attachment includes a body portion having an angled plate attached to a bottom plate. The attached angled plate and bottom plate are oriented to fit an outside corner of the case, a shape similar to a corner bracket with a bottom platform where the case corner would rest. There is included a fastener receiving portion that is affixed to the body portion, I envision this portion being molded, at the corner of the angled plate, along with the body portion to form an integral piece. The body portion has a hole, and may include a plurality of holes, formed therethrough for receiving a rivet. The fastener receiving portion has a threaded bore; a fastener is attached to a wheel, such wheels being commonly known in the art, and the fastener is attachable and detachable to the threaded bore, so it can come off and be placed back on—this is handy when the case is stowed.

The caster attachment, because it supports from outside the outer periphery of a case, lowering the center of gravity of a case. This makes the case more maneuverable and safer to wheel around because it is less likely to tip.

Too, our invention has a stepped design which prevents catching or snagging that might occur. This is done by eliminating gaps between the faces of the attachment and the outside surface of the case. Particularly true where the case has ribs on its exterior face, which the inventive caster attachment engages via its stepped section or sections. So, the present invention provides a stepped section on the body portion of the caster attachment to allow for close fitting and support of the case by the caster attachment preventing catching of items that would occur if the stepped sections were not present. This stepped design also provides added strength, and a strong more durable appearance, to the case and attachment because it eliminates any gaps between the caster attachment and the surface of the case.

There is at least one hole with at least one recess used to fit rivets. The heads of the rivet heads are prevented from shearing off or wearing away because they fit into the recess, but certainly a design is possible where they do not fit into the recess. We determined that the best mode is to provide that recess fit.

We have invented an embodiment of the present invention having a threaded bore of at least 0.75 inches. This is ideal but other lengths in different embodiments are possible. We have also invented an example of the invention where the fastener receiving portion is integrally affixed to the body portion. We envision this being through a molded manufacturing process, or even a welding process. Though many ways can be used to affix the body portion and the fastener receiving portion.

Another embodiment of the present invention has an axis of the threaded bore, particularly longitudinal. In such an example, the axis of the threaded bore is substantially perpendicular to a plane of the bottom plate, though certainly other orientations are possible. Too, the threaded bore is located outside of a boundary of the bottom plate. This configuration of the threaded bore adds dimension to the overall case and makes the case more stable, effectively by lowering the center of gravity of the case.

Another embodiment of the invention comprises a stepped section formed into the body portion. The stepped section being engageable with a rib located on the case.

Other embodiments we have invented are an inventive caster attachment where the body portion is formed with a recess surrounding one end of the hole. Still another is where the caster attachment comprises for the rivet to pass through the hole. Then the rivet being attachable to the case with a head of the rivet fitting within the recess. The head of the rivet may sit substantially flush with an outer boundary of the body portion.

Yet another embodiment of the present invention comprises the caster attachment with an outer face of the angled plate. The outer face of the angled plate having a message display area. Another inventive example is a caster attachment wherein the body portion and the fastener receiving portion are manufactured from A380 aluminum alloy.

Too, the caster attachment being attached to the case provides an appearance of the case being more durable relative to cases without the caster attachment. We believe this is largely due to the stepped appearance and design with the riveting.

An embodiment of the caster attachment could comprise an adjustable case dimension via the use of caster wheels of different sizes, effectively changing the overall dimension of the case. Too, the caster attachment could have an angled plate and bottom plate having a thickness of at least 0.13 inches, or the stepped section having a setoff of at least 0.09 inches. Too, the invention could comprise the recess having a depth of at least 0.0625 inches and a width of at least 0.4375 inches while the hole has a width of at least 0.2031 inches.

The present invention provides for easy attachment and detachment of a caster's caster wheel. This is provided for via a threaded caster wheel bolt and the bolt receiving hole on a portion of the attachment. We have invented too in the present invention a way that provides for a deception in appearance making the case appear more durable. Also, the present invention provides for an adjustable case dimension, for shipping purposes, because it can be used with a great many sizes and shapes of attachable and detachable caster wheels.

### BRIEF DESCRIPTION OF THE SEVERAL VIEWS OF THE DRAWINGS

These and other features, aspects and advantages of the present invention will become better understood with regard to the following description, appended claims, and accompanying drawings where:

FIG. 1 shows a side view of an embodiment of the present invention without the caster wheel inserted.

FIG. 2 shows a side view of another side of an embodiment of the present invention without the caster wheel inserted.

FIG. 3 shows a side cutaway view of a side of an embodiment of the present invention without the caster wheel inserted.

FIG. 4 shows a side cutaway view of another side of an embodiment of the present invention without the caster wheel inserted.

FIG. 5 shows a top view of an embodiment of the present invention without the caster wheel inserted.

FIG. 6 shows a bottom view of an embodiment of the present invention without the caster wheel inserted.

FIG. 7 shows a perspective view of an embodiment of the present invention.

FIG. 8 shows a side view of a side of an embodiment of the present invention with a caster wheel inserted.

FIG. 9 shows a perspective view of an embodiment of the present invention.

### DESCRIPTION

### Overview.

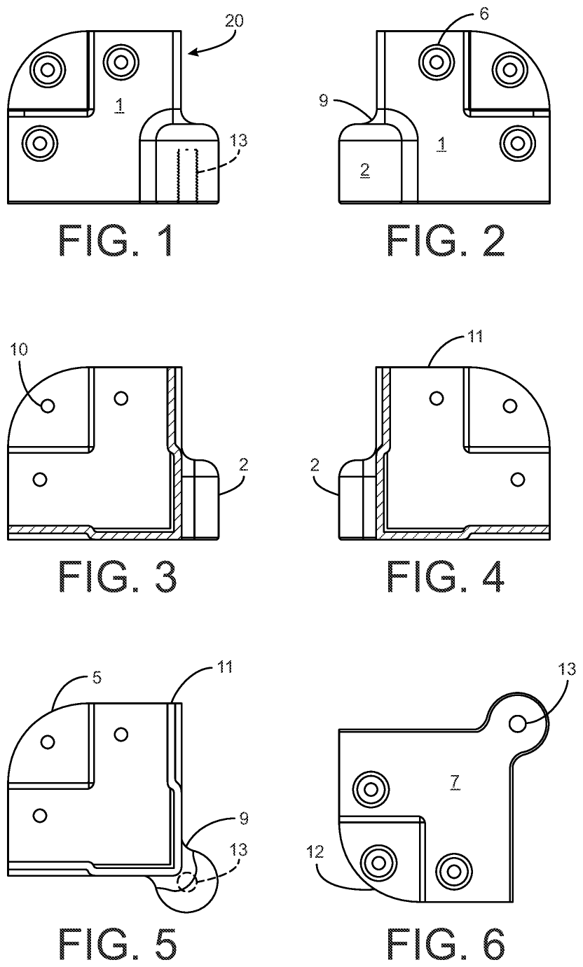

The present invention provides a caster attachment used for attaching a wheel to a case. As shown in FIG. 1 through FIG. 6, the caster attachment 20 comprises a body portion 1. The body portion having an angled plate 11 attached to a bottom plate 7 wherein the attached angled plate 11 and bottom plate 7 are oriented to fit an outside corner of the case. Shown is a fastener receiving portion 2. The fastener receiving portion 2 being affixed to the body portion 1, in this instance via a weld 9. The body portion 1 having a hole 10 formed therethrough for receiving a rivet (not shown), rivets being commonly known. The fastener receiving portion 2 having a threaded bore 13.

The present invention shown has a threaded bore 13. The holes have a recess 6 at one end. The plates can have rounded corners 5.

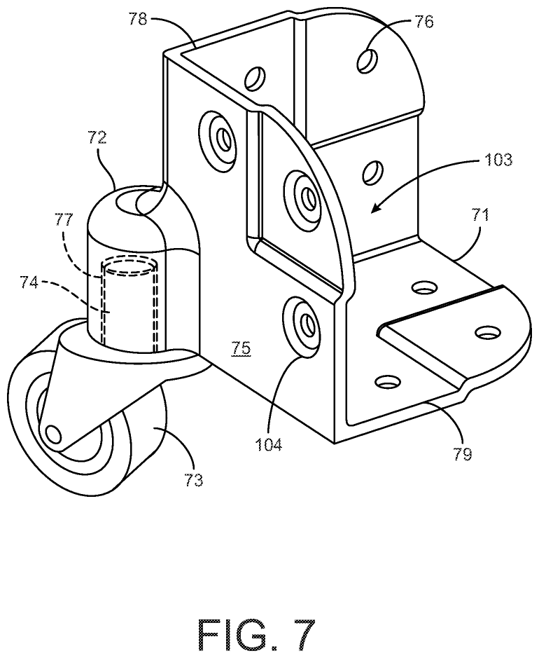

As show in FIG. 7, a perspective view of an embodiment of the present invention comprises a fastener 74. The fastener 74 being attached to the wheel 73. The fastener 74 being attachable and detachable to the threaded bore 77. The threaded bore 77 being formed into the fastener receiving portion 72. The fastener receiving portion is connected to the body portion 75. As is shown, the body portion has holes 76 with recesses 104 and a stepped section 71.

The embodiment has a bottom plate 79 which is attached to an angled plate 78 which are oriented to form a space 103 for receiving a case corner.

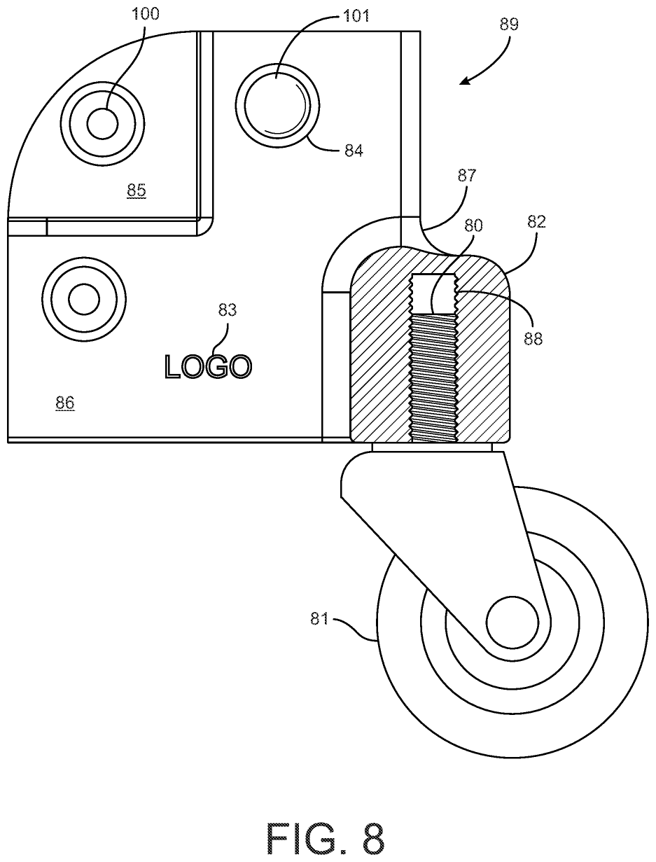

As shown in FIG. 8, a side view of a side of an embodiment of the present invention with a caster wheel inserted comprises a caster attachment 89. The caster attachment has a body portion 86. The body portion 86 has a stepped section 85. A wheel 81, commonly known, is connected to a fastener 80 which may be attached and detached to a fastener receiving portion 82 by being rotated in or out of a threaded bore 88.

The fastener receiving portion 82 is integrally attached to the body portion 86, we envision this being at manufacture, as can be seen at 87.

In the shown embodiment, the body portion 86 has holes 100 therethrough which are for passing a rivet 101 or rivets, the head of the rivet fits in a recess 84 and is substantially flush with the outer boundary of the body portion 86. This flushness of the rivet heads prevents snagging of articles. This can be achieved by the heads being somewhat flush or being rounded for instance.

The body portion 86 of the caster attachment 89 has a messaging area 83 located on the body portion's outer boundary or face. In this instance, the message in the messaging area 83 is an embossed logo.

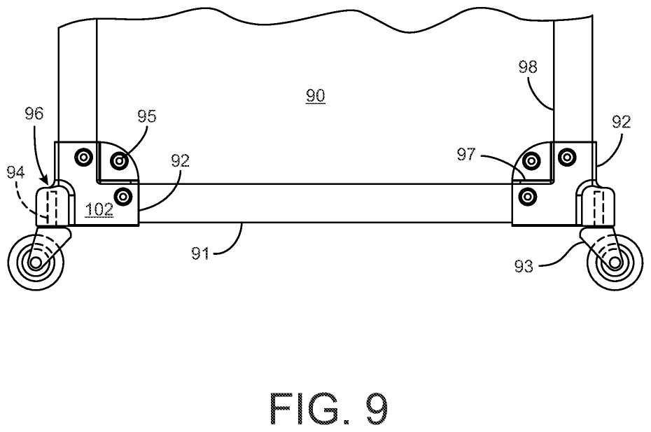

As shown in FIG. 9, a perspective view of an embodiment of the present invention comprises a case 90. The bottom of the case 91 is set onto a pair of the inventive caster attachments 92. Rivets 95 secure the caster attachment 92 to the case 90. The case 90 has a rib 98 as part of its design. There is a stepped section 97 of the caster attachment 92, in this example with rounded corners, that engages the rib 98. Wheels 93 are attached to the caster attachment 92 via a fastener which is threaded into a threaded bore 94. Notably, the threaded bore 94 lies outside of the perimeter of the caster attachment's body portion 102 as shown at 96.

Although the present invention has been described in considerable detail with the reference to certain preferred versions thereof, other versions are possible. For instance, the attachment can be made to work with cases having no ribbing. Too, we envision an embodiment where the panel sizes are minimal thus allowing a flatter design which may not extend above the sides of a case and engage any ribs. Therefore, the spirit and scope of the appended claims should not be limited to the description of the preferred versions contained herein.

Any element in a claim that does not explicitly state “means for” performing a specified function, or “step for” performing a specific function, is not to be interpreted as a “means” or “step” clause as specified in 35 U.S.C. § 112, ¶ 6. In particular, the use of “step of” in the claims herein is not intended to invoke the provisions of 35 U.S.C. § 112, ¶ 6.

What I claim is:

1. A caster attachment used for attaching a wheel to a case, the caster attachment comprising:
a body portion;
the body portion having an angled plate attached to a bottom plate wherein the attached angled plate and bottom plate are oriented to fit an outside corner of the case;
a fastener receiving portion;
the fastener receiving portion being affixed to the body portion;
the body portion having a hole formed therethrough for receiving a rivet;
the fastener receiving portion having a threaded bore;
a fastener;
the fastener being attached to the wheel;
the fastener being attachable and detachable to the threaded bore.

2. The caster attachment of claim 1 wherein the threaded bore has a length of at least 0.75 inches.

3. The caster attachment of claim 1 wherein the fastener receiving portion is integrally affixed to the body portion.

4. The caster attachment of claim 1 further comprising:
an axis of the threaded bore;
the axis of the threaded bore being perpendicular to a plane of the bottom plate;
the threaded bore being located outside of a boundary of the bottom plate.

5. The caster attachment of claim 1 further comprising:
a stepped section formed into the body portion;
the stepped section being engageable with a rib located on the case.

6. The caster attachment of claim 1 further comprising:
the body portion being formed with a recess surrounding one end of the hole.

7. The caster attachment of claim 6 further comprising:
the rivet passing through the hole;
the rivet being attachable to the case;
a head of the rivet fitting within the recess substantially flush with an outer boundary of the body portion.

8. The caster attachment of claim 1 further comprising:
an outer face of the angled plate;
the outer face of the angled plate having a message display area.

9. The caster attachment of claim 1 wherein the body portion and the fastener receiving portion are manufactured from A380 aluminum alloy.

10. The caster attachment of claim 1 wherein the caster attachment being attached to the case provides an appearance of the case being more durable relative to cases without the caster attachment.

11. The caster attachment of claim 1 further comprising an adjustable case dimension via the use of caster wheels of different sizes.

12. The caster attachment of claim 1 wherein the angled plate and bottom plate each have a thickness of at least 0.13 inches.

13. The caster attachment of claim 4 wherein the stepped section has a setoff of at least 0.09 inches.

14. The caster attachment of claim 5 wherein the recess has a depth of at least 0.0625 inches and the recess has a width of at least 0.4375 inches and the hole has a width of at least 0.2031 inches.

15. A caster attachment used for attaching a wheel to a case, the caster attachment comprising:
a body portion;
the body portion having an angled plate attached to a bottom plate wherein the attached angled plate and bottom plate are oriented to fit an outside corner of the case;
a fastener receiving portion;
the fastener receiving portion being affixed to the body portion;
the body portion having a hole formed therethrough for receiving a rivet;
the fastener receiving portion having a threaded bore;
a fastener;
the fastener being attached to the wheel;
the fastener being attachable and detachable to the threaded bore;
the threaded bore having a length of at least 0.75 inches;
the fastener receiving portion being integrally affixed to the body portion;
an axis of the threaded bore;
the axis of the threaded bore being perpendicular to a plane of the bottom plate;
the threaded bore being located outside of a boundary of the bottom plate;
a stepped section formed into the body portion;
the stepped section being engageable with a rib located on the case;
the body portion being formed with a recess surrounding one end of the hole;
the rivet passing through the hole;
the rivet being attachable to the case;
a head of the rivet fitting within the recess substantially flush with an outer boundary of the body portion;
an outer face of the angled plate;
the outer face of the angled plate having a message display area;
the body portion and the fastener receiving portion are manufactured from A380 aluminum alloy;
the angled plate and bottom plate each having a thickness of at least 0.13 inches;
the stepped section having a setoff of at least 0.09 inches;
the recess having a depth of at least 0.0625 inches and the recess having a width of at least 0.4375 inches and the hole having a width of at least 0.2031 inches.
